(19) United States
(12) Patent Application Publication
(10) Pub. No.: US 2014/0006162 A1
(43) Pub. Date: Jan. 2, 2014

(54) PROFILE CONSTRUCTION BASED ON ASSERTED INTEREST AND ACTUAL PARTICIPATION IN ASSOCIATED ACTIVITIES

(71) Applicants: Patrick John Ennis, Fall City, WA (US); Alexander Knight, Seattle, WA (US); Vlad Grigore Dabija, Grandville, MI (US); Timothy Martin Londergan, Seattle, WA (US); Dominic Dan Suciu, Edmonds, WA (US); Raghuram Madabushi, Seattle, WA (US); David Walter Ash, Bellevue, WA (US)

(72) Inventors: Patrick John Ennis, Fall City, WA (US); Alexander Knight, Seattle, WA (US); Vlad Grigore Dabija, Grandville, MI (US); Timothy Martin Londergan, Seattle, WA (US); Dominic Dan Suciu, Edmonds, WA (US); Raghuram Madabushi, Seattle, WA (US); David Walter Ash, Bellevue, WA (US)

(73) Assignee: Empire Technology Development, LLC, Wilmington, DE (US)

(21) Appl. No.: 13/823,090

(22) PCT Filed: Jun. 30, 2012
(86) PCT No.: PCT/US12/45164

§ 371 Date: Mar. 13, 2013

(51) Int. Cl. G06Q 30/02

(52) U.S. Cl. CPC G06Q 30/0269
USPC 705/14.58; 705/14.66

(57) ABSTRACT

Technologies are provided for building a profile for a person based on an asserted interest and actual participation of the person in activities associated with the asserted interest. An online event such as a social networking event involving the person online may be a reflection of either their aspirational self or their real self. In some examples, a hypothesis may be generated as to whether it is likely to be aspirational or real. The hypothesis may be proven or disproven by identifying activities actually participated in by the person, in other words, comparing their actions and/or behavior in the physical and/or virtual world with what they assert about themselves in the virtual world. The profiles for the aspirational and real personas may be accurately constructed based on the hypothesis and used, for example, in targeted marketing.

### BACKGROUND

Unless otherwise indicated herein, the materials described in this section are not prior art to the claims in this application and are not admitted to be prior art by inclusion in this section.

For successful marketing of services, products, etc., a defined group with known attributes is highly desired. In today's networked environment, one of the fruitful resources for determining attributes such as age, location, interests, economic status, etc. are online activities of and assertions from people. However, what one says may be different from what one typically does. People may assert something frequently but do things contrary to what was said. For example, a person may claim to be environmentally conscious and proclaim to be careful about using public transportation, but in reality may hardly ever use public transportation. People may present a persona online that may be close or drastically different from their real persona. Another example may be someone showing interest in running by participating in running related chat rooms, visiting running accessory stores online, etc. However, the person's actual purchasing habits, actual sign-up for races, etc. may not back up the asserted online persona that is a running enthusiast.

### SUMMARY

The present disclosure generally describes techniques for constructing a profile for a person based on asserted interest(s) and actual participation in activities associated with the asserted interest(s). According to some embodiments, the present disclosure describes a method for building a profile for a person based on an asserted interest and actual participation of the person in activities associated with the asserted interest. The method may include identifying the asserted interest of the person; determining the activities associated with the asserted interest; identifying activities actually participated in by the person; and building the profile of the person based on the asserted interest and the activities actually participated in by the person.

According to other embodiments, the present disclosure further describes a server for building a profile for a person based on an asserted interest and actual participation of the person in activities associated with the asserted interest. The server may include a memory configured to store instructions, a communication module configured to facilitate communications with one or more computing devices and one or more communication network servers, and a processor configured to execute a profile determination module in conjunction with the instructions stored in the memory. The profile determination module may be configured to identify the asserted interest of the person; determine the activities associated with the asserted interest; identify activities actually participated in by the person; and build the profile of the person based on the asserted interest and the activities actually participated in by the person.

According to further embodiments, the present disclosure also describes a computer readable memory device with instructions stored thereon for building a profile for a person based on an asserted interest and actual participation of the person in activities associated with the asserted interest. The instructions may include identifying the asserted interest of the person; determining the activities associated with the asserted interest; identifying activities actually participated in by the person; and building the profile of the person based on the asserted interest and the activities actually participated in by the person.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 conceptually illustrates a person having multiple profiles (or personas) for their online interactions with social networks, professional networks, online merchants, and so on;

FIG. 2 illustrates an example scenario, where a data mining entity may collect information associated with a person's asserted interest and activities to build a profile for that person;

FIG. 3 illustrates another example scenario, where a communication network such as a social network or a professional network may collect information associated with a person's asserted interest and activities to build a profile for that person;

FIG. 4 illustrates a general purpose computing device, which may be used to build a profile for a person based on asserted interest(s) and actual participation in activities associated with the asserted interest(s);

FIG. 5 is a flow diagram illustrating an example method that may be performed by a computing device such as the computing device in FIG. 4; and

FIG. 6 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to constructing a profile for a person based on asserted interest(s) and actual participation in activities associated with the asserted interest(s).

Briefly stated, technologies are provided for building a profile for a person based on an asserted interest of the person and actual participation by the person in activities associated with the asserted interest. An online event such as a social networking event involving the person online may be a reflection of either their aspirational self or their real self. In some examples, a hypothesis may be generated as to whether it is likely to be aspirational or real. The hypothesis may be proven or disproven by, for example, identifying activities actually participated in by the person, in other words, comparing their actions and/or behavior in the physical and/or virtual world with what they assert about themselves in the virtual world. The profiles for the aspirational and real personas may be accurately constructed based on the hypothesis and used, for example, in targeted marketing.

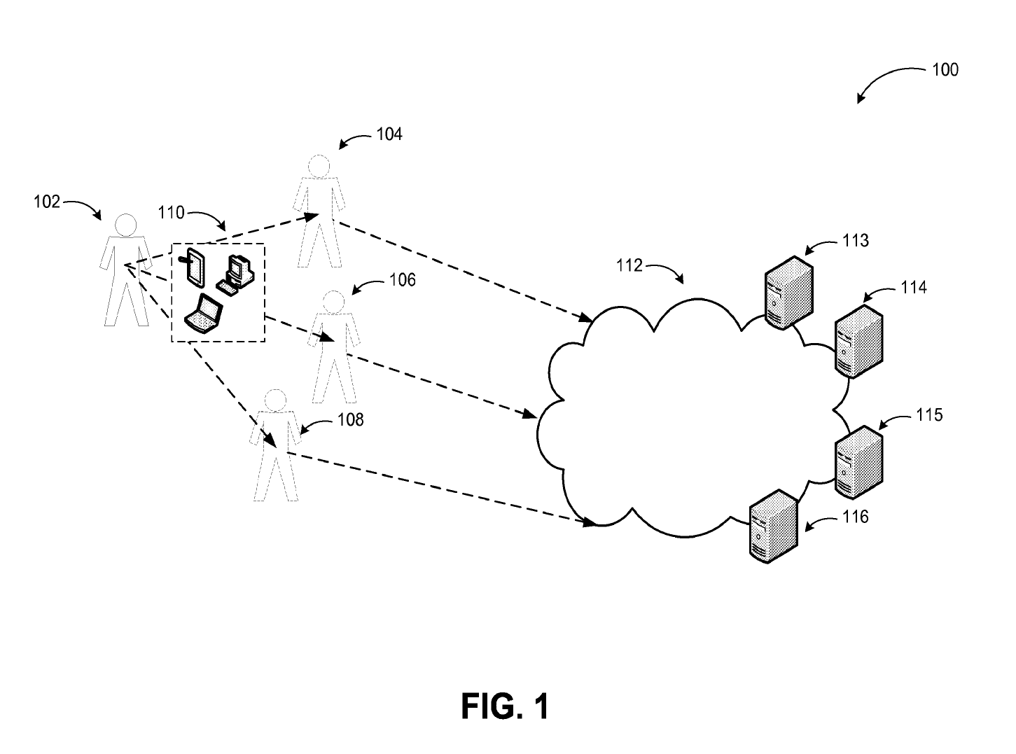

FIG. 1 conceptually illustrates a person having multiple profiles (or personas) for their online interactions with social networks, professional networks, online merchants, and so on, arranged in accordance with at least some embodiments described herein.

With the proliferation of networking technologies, Internet based and other networked communications have become a substantial aspect of people's daily lives. Not only do people exchange work-related information over various networks, but personal communications, participation in community events, purchasing activities, and many more take place online. With these developments, marketing approaches for products and services have also changed. While conventional marketing was directed to surveys, observation of people's shopping habits, etc., in the new, connected world, an increased emphasis is placed on people's online behavior. One of the challenges in determining a marketing profile for a person in the virtual world is whether or not they are who they claim to be, because the online world enables people to easily create different personas and assert interests that may have nothing to do with their real persona.

A diagram 100 in FIG. 1 shows a conceptual interaction of a person 102 with the virtual world. In an example, the person 102 may interact with a variety of online resources such as social networks, professional networks, online merchants, interest groups, or similar online entities illustratively represented by servers 113 through 116. The person 102 may employ a number of devices and applications 110 to communicate with the different online resources. For example, the person 102 may use a desktop computer at work for posting content to a professional network, exchanging work-related messages, purchasing work-related products, and so on. The person 102 may use a laptop computer at home for posting content to a social network, exchanging personal messages, participating in chat groups, purchasing personal products, and so on. The person 102 may also employ a handheld device such as a smart phone to perform any of the above actions while traveling or on vacation. Of course other forms of communication devices, exchanges, and activities may be employed or performed in other scenarios. The person 102 may assert different personas 104, 106, or 108 in their interactions with the online resources. For example, one persona may be presented in their interactions with social networks and personal shopping resources, while another persona may be presented in their interactions with professional networks and work-related resources. The communications may occur over one or more networks 112 such as the Internet, home networks, neighborhood networks, enterprise networks, cellular networks, and similar ones.

According to some examples, a profile may be constructed for the person 102 based on their asserted interests online and actual participation in activities associated with the asserted interests. A hypothesis may be generated as to whether an asserted interest is likely to be aspirational or real. A system according to some embodiments may generate the hypothesis based on analyzing asserted interests of a person online. For example, the person may identify his/her personal attributes in a social of professional network as being a soccer enthusiast or may subscribe to soccer news feeds. The system may determine activities associated with such an interest, for example, purchasing soccer tickets, participating in soccer-related chat rooms, purchasing team memorabilia, etc. Then, the hypothesis may be defined as: “the person has a profile of a soccer enthusiast, if it can be confirmed they participate in X number of Y activities identified as being associated with soccer.” The hypothesis may then be tested by identifying activities actually performed by the person 102 and comparing their actions with what they assert about themselves. The profiles for the aspirational and real personas may be accurately constructed based on the hypothesis and used, for example, in targeted marketing. Thus, if the example hypothesis above is confirmed, it may be assumed that “soccer enthusiast” is the person's real persona. On the other hand, if the hypothesis is not confirmed, it may be assumed that “soccer enthusiast” is the person's aspirational persona.

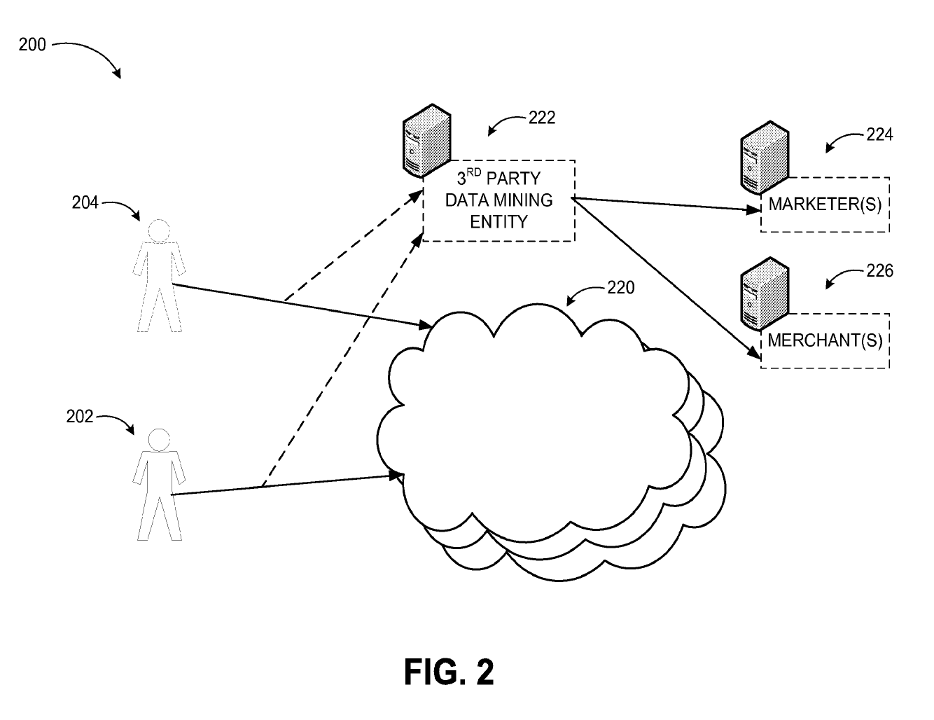

FIG. 2 illustrates an example scenario, where a data mining entity may collect information associated with a person's asserted interest and activities to build a profile for that person, arranged in accordance with at least some embodiments described herein.

A diagram 200 includes two different personas 202 and 204 of the same person interacting with the online world represented by networks 220. The interactions may be analyzed to determine asserted interests, identify activities associated with those interests, and determine if actual activities match the identified ones in order to build a reliable profile—whether it is aspirational or real—for the person. The asserted interests may be determined based on declarations of the person such as online attributes declared by the person or based on inferences from the person's online activities such as membership in particular interest groups, chat rooms, shopping habits, and comparable ones. The activities associated with the asserted interests may be identified based on a predefined list of interests and activities (e.g., stored at a default interest—activity database). In other examples, the activities may be identified employing an intelligent learning algorithm or similar mechanism that may analyze potential online activities or online indications of physical activities against predefined interests. The determination of whether actual activities match the identified ones may be performed by first identifying the person's actual activities (online activities or online indications of physical activities) and then comparing those to the identified activities associated with the asserted interest. One or more computing devices (e.g., servers) and applications may be employed to perform these tasks using one or more algorithms (e.g., intelligent learning algorithms, comparison algorithms, etc.). The analysis may be performed by a third party data mining entity 222 in the illustrated example scenario. The third party data mining entity 222 may then provide the profile(s) to one or more marketers 224 or merchants 226, who may be able to target their marketing activities based on the accurate profile information. The constructed profile information may be valuable to, for example, advertisers. For example, it may assist marketers to understand a value of a person's profile—the aspirational person vs. the real person. Each of these personas may be targeted differently for various marketing purposes.

Such a determination may provide context to addressing the person (who may be a target of a marketing campaign). For example, the “real” persona may be something that the person tends to do while they are working, whereas the “aspirational” may be something they do while on vacation. Not noticing this nuance may impact the success of a targeted marketing campaign. In some examples, the context may be location specific. The aspirational persona may be addressed when the person is in certain locations (e.g., vacation or home), while the real persona may be addressed when in certain other locations (e.g., work).

If there is a strong correlation between someone's aspirational self and their real self, the value of the profile may be higher for marketers. Where there is a substantial gap, the value of the profile may be lower because everything the person does or asserts may need to be evaluated as to whether it is “real” or just “aspirational”, and the evaluation may be wrong.

Determining which aspects of a person's online persona reflect the real persona vs. the aspirational persona may include a number of considerations. For example, favorite online activities may be aspirational but messages to others may be real. Because actually following someone around in the physical world to confirm their real persona may be difficult, online clues may be sought as to their activities in the physical world. For example, a person's online personal or business calendar may provide indications of their physical activities such as attending an interest group meeting, a sports game, etc. even if the person did not arrange for those activities through online meetings. Other online indications or clues may be derived from searches performed by the person, message exchanges related to the physical activities, and so on. In another example, if someone lists their activities on a social or professional network, activities reflecting their aspirational persona may be those they update rarely. On the other hand, frequent messages as to their current activities on may be a reflection of their real persona.

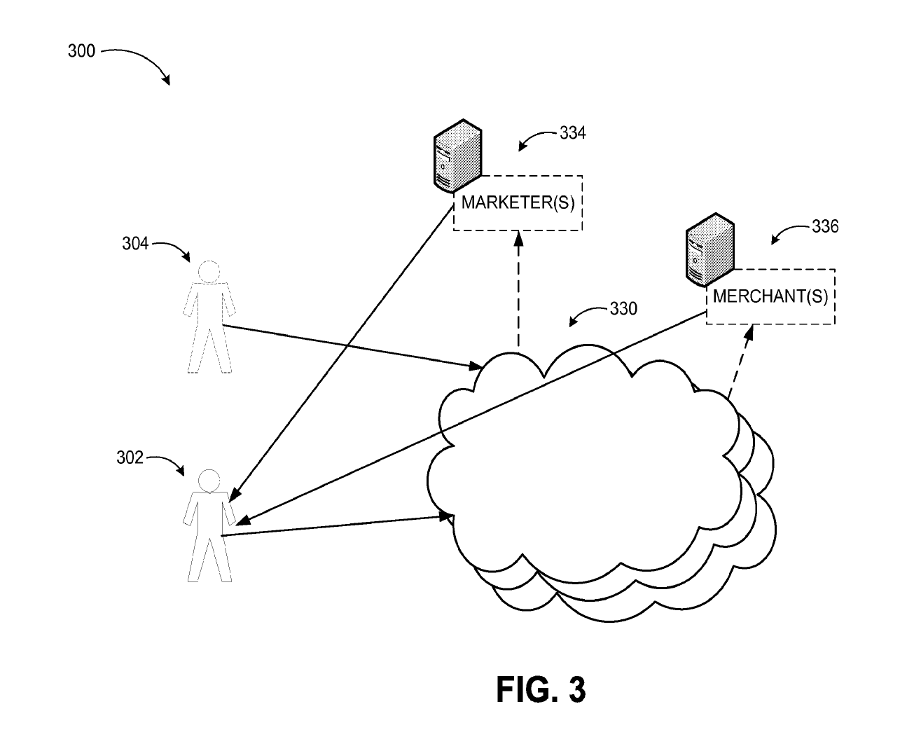

FIG. 3 illustrates another example scenario, where a communication network such as a social network or a professional network may collect information associated with a person's asserted interest and activities to build a profile for that person, arranged in accordance with at least some embodiments described herein.

A diagram 300 presents an alternative scenario to that discussed above in conjunction with FIG. 2. According to the scenario in the diagram 300, different personas 302 and 304 presented to the virtual world by the same person may interact with different online resources such as social networks, professional networks, online merchants, and so on. One or more of the online resources such as a social network, a professional network, or an online consolidator may collect information about the interactions such as asserted interests, participated activities, etc. The online resource collecting the information may then provide that information to a marketer 334 or a merchant 336, who can build a profile for the person (or their different personas) and target the marketing activities accordingly. Alternatively, the online resource collecting the information may build the profile(s) based on the collected information and submit the profile(s) to the marketer 334 or the merchant 336.

Embodiments are not limited to building a profile based on a person's asserted interests and actual behavior for marketing purposes. The constructed profile(s) may be useful for potential employers, groups recruiting supporters, landlords, and anyone else who may be interested in determining a person's self-identification in the virtual world and their actual self in the real world.

An online event such as a social networking event, a professional networking event, a message exchange, or similar activity involving a user online may be a reflection of either their aspirational persona or their real persona. Thus, a hypothesis may be generated as to whether it is likely to be aspirational or real. The hypothesis may state that a person's profile includes one or more asserted interests. Testing whether such a hypothesis is valid or not may be useful, for example, querying whether the user actually did some activity associated with the one or more asserted interests they said they were going to do. By comparing the person's actions/behavior in the physical world with what they say about themselves (and their actions/behavior) in the virtual world, both worlds may be integrated. Online indications or clues about the person's physical activities may be derived from online calendar(s), searches performed by the person, message exchanges related to the physical activities, and so on. A strong correlation between the two (i.e., aspirational and real personas or virtual and real worlds) may tend to validate the profile of the person as being a possible way to market to them. If the correlation is weak, then the question may arise as to whether to market to the person's virtual self or their physical self While, marketing to a person's physical self (real persona) may make sense commonly, there may be exceptions. If someone has an aspirational persona, then there may be times when they are acting towards that persona, which be targeted for marketing.

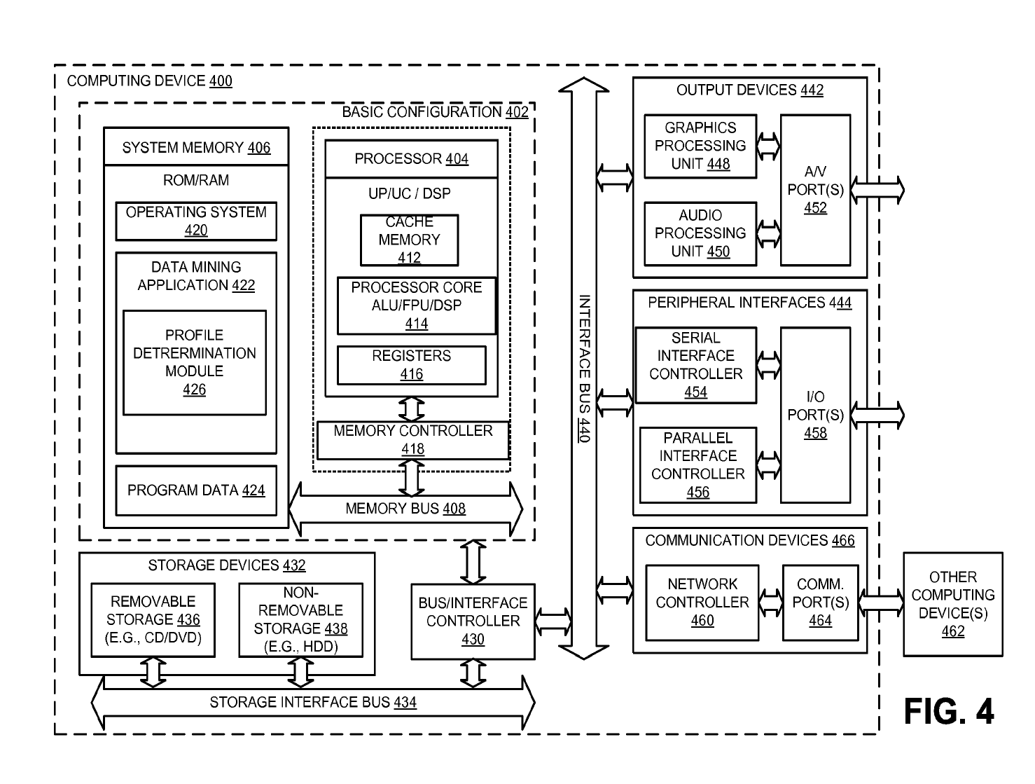

FIG. 4 illustrates a general purpose computing device, which may be used to build a profile for a person based on asserted interest(s) and actual participation in activities associated with the asserted interest(s), arranged in accordance with at least some embodiments described herein. In a very basic configuration 402, computing device 400 typically includes one or more processors 404 and a system memory 406. A memory bus 408 may be used for communicating between processor 404 and system memory 406.

Depending on the desired configuration, the processor 404 may be of any type including but not limited to a microprocessor (μP), a microcontroller (μC), a digital signal processor (DSP), or any combination thereof. The processor 404 may include one more levels of caching, such as a level cache memory 412, a processor core 414, and one or more registers 416. An example processor core 414 may include an arithmetic logic unit (ALU), a floating point unit (FPU), a digital signal processing core (DSP Core), or any combination thereof. An example memory controller 418 may also be used with the processor 404, or in some implementations the memory controller 418 may be an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 may include an operating system 420, one or more applications such as data mining application 422, and program data 424. The data mining application 422 may include a profile determination module 426 that is arranged to construct a profile for a person based on asserted interest(s) and actual participation in activities associated with the asserted interest(s). Program data 424 may include profile data, activities data, and similar data. The program data 424 may be useful in monitoring asserted interests and actual participation to determine a profile for a user. This described basic configuration 402 is illustrated in FIG. 4 by those components within the inner dashed line.

The computing device 400 may have additional features or functionality, and additional interfaces to facilitate communications between the basic configuration 402 and any required devices and interfaces. For example, a bus/interface controller 430 may be used to facilitate communications between the basic configuration 402 and one or more data storage devices 432 via a storage interface bus 434. The data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (e.g., output devices 442, peripheral interfaces 444, and communication devices 446) to the basic configuration 402 via the bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 400 may also be implemented as a personal computer including both laptop computer and non-laptop computer configurations. Moreover the computing device 400 may be implemented as a networked system or as part of a general purpose or specialized server.

Example embodiments may also include methods. These methods can be implemented in any number of ways, including the structures described herein. One such way is by machine operations, of devices of the type described in the present disclosure. Another optional way is for one or more of the individual operations of the methods to be performed in conjunction with one or more human operators performing some of the operations while other operations are performed by machines. These human operators need not be collocated with each other, but each can be only with a machine that performs a portion of the program. In other examples, the human interaction can be automated such as by pre-selected criteria that are machine automated.

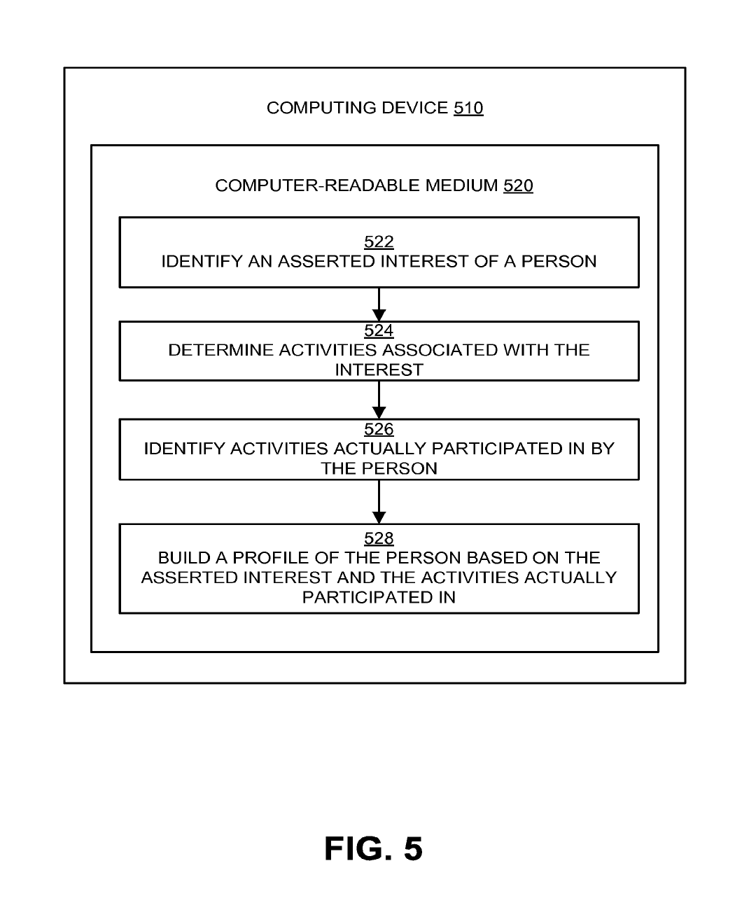

FIG. 5 is a flow diagram illustrating an example method that may be performed by a computing device such as the computing device 400 in FIG. 4, arranged in accordance with at least some embodiments described herein.

Example methods may include one or more operations, functions or actions as illustrated by one or more of blocks 522, 524, 526 and/or 528. The operations described in blocks 522 through 528 may also be stored as computer-executable instructions in a computer-readable medium such as a computer-readable medium 520 of a computing device 510.

A process for constructing a profile for a person based on asserted interest and actual participation of the person in associated activities may begin with block 522, “IDENTIFY AN ASSERTED INTEREST OF A PERSON.” At block 522, a merchant, a marketing entity, a social network, a data mining entity, or similar entity may determine one or more interests of a person based on their active assertions or behavior online. The asserted interests may be determined based on declarations of the person such as online attributes declared by the person or based on inferences from the person's online activities such as membership in particular interest groups, chat rooms, shopping habits, and comparable ones. For example, a person subscribing to an environmental chat group or a skiing interest group may indicate an asserted interest in environmental causes or skiing, respectively.

Block 522 may be followed by block 524, “DETERMINE ACTIVITIES ASSOCIATED WITH THE INTEREST.” At block 524, the entity identifying the asserted interest(s) may determine one or more activities related to the asserted interest. The activities associated with the asserted interests may be identified based on a predefined list of interests and activities. The activities may also be identified employing an intelligent learning algorithm or similar mechanism that may analyze potential online activities or online indications of physical activities against predefined interests. For example, activities related to environmental causes may include signing online petitions, paid memberships in environmental organizations, participation in meetings or rallies, etc. Similarly, activities related to a skiing interest may include purchasing ski equipment, subscription to skiing magazines, booking trips to ski destinations, and so on.

Block 524 may be followed by block 526, “IDENTIFY ACTIVITIES ACTUALLY PARTICIPATED IN BY THE PERSON.” At block 526, the above discussed entity (or entities) may identify actually participated activities (physical or online) through online indications or clues derived from searches performed by the person, online calendars, message exchanges related to the physical activities, and comparable sources. The entity may then determine which of the identified activities the person actually participates in such as booking ski destination trips, attending an environmental rally, etc.

Block 526 may be followed by block 528, “BUILD A PROFILE OF THE PERSON BASED ON THE ASSERTED INTEREST AND THE ACTIVITIES ACTUALLY PARTICIPATED IN.” At block 528, an aspirational persona profile and/or a real persona profile may be constructed for the person. This may be accomplished by comparing the actually participated activities to the asserted interests.

The blocks included in the above described process are for illustration purposes. Profile construction based on asserted interest and actual participation in associated activities may be performed by similar processes with fewer or additional blocks. In some examples, the blocks may be performed in a different order. In some other examples, various blocks may be eliminated. In still other examples, various blocks may be divided into additional blocks, or combined together into fewer blocks. Although illustrated as sequentially ordered operations, in some implementations the various operations may be performed in a different order, or in some cases various operations may be performed at substantially the same time.

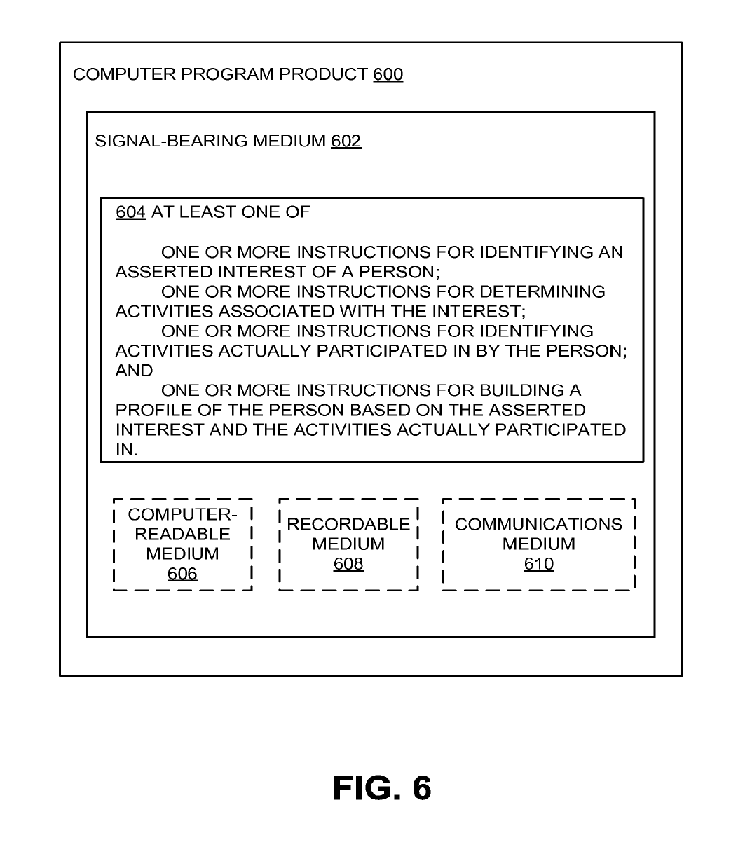

FIG. 6 illustrates a block diagram of an example computer program product, arranged in accordance with at least some embodiments described herein. In some examples, as shown in FIG. 6, a computer program product 600 may include a signal bearing medium 602 that may also include machine readable instructions 604 that, when executed by, for example, a processor, may provide the functionality described above with respect to FIG. 4 and FIG. 5. Thus, for example, referring to the processor 404, the profile determination module 426 may undertake one or more of the tasks shown in FIG. 4 in response to instructions 604 conveyed to processor 404 by the signal bearing medium 602 to perform actions associated with constructing a profile for a person based on asserted interests and actual participation in activities associated with the asserted interests as described herein. Some of those instructions may include identifying an asserted interest of a person, determining activities associated with the interest, identifying activities actually participated in by the person, building a profile of the person based on the asserted interest and the activities actually participated in.

In some implementations, the signal bearing medium 602 depicted in FIG. 6 may encompass a computer-readable medium 606, such as, but not limited to, a hard disk drive, a Compact Disc (CD), a Digital Versatile Disk (DVD), a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, the program product 600 may be conveyed to one or more modules of the processor 404 by an RF signal bearing medium, where the signal bearing medium 602 is conveyed by a wireless communications medium 610 (e.g., a wireless communications medium conforming with the IEEE 802.11 standard).

The present disclosure describes a method for building a profile for a person based on an asserted interest and actual participation of the person in activities associated with the asserted interest. The method may include identifying the asserted interest of the person; determining the activities associated with the asserted interest; identifying activities actually participated in by the person; and building the profile of the person based on the asserted interest and the activities actually participated in by the person.

The method may further include determining aspirational and real aspects of the person's online persona; and building a real profile based on the real aspects and an aspirational profile based on the aspirational aspects. The method may also include enabling adjustment of a marketing strategy for the real profile and the aspirational profile, providing a first marketing strategy for the real profile and a second marketing strategy for the aspirational profile based on a location-specific context, or inferring real activities of the person in a physical world from clues associated with the person's online persona. Activities rarely updated online may be presumed to indicate the aspirational aspects and activities updated frequently online may be presumed to indicate the real aspects. Activities indicated as favorite but not otherwise referenced may be presumed to indicate the aspirational aspects and activities referenced in communications may be presumed to indicate the real aspects.

The method may further include integrating a physical world and a virtual world associated with the person by comparing the person's actions and/or behavior in the physical world with what the person asserts about themselves in the virtual world. The method may yet include creating a hypothesis on whether a given online networking event involving the person is likely to be a reflection of an aspirational aspect of the person or a real aspect of the person. The online networking event may be associated with one or more of a social network, a professional network, and a blog. The method may include testing whether the hypothesis is valid or not, where the testing includes querying whether the person actually performed an activity they asserted they would perform. The hypothesis may be validated if a strong correlation is determined between the real aspect and the aspirational aspect of the person. The method may further include determining an influencer whose aspirational aspects and real aspects match substantially, where the profile is built by one of a data mining entity, a marketing entity, a social network, and/or a professional network.

The present disclosure further describes a server for building a profile for a person based on an asserted interest and actual participation of the person in activities associated with the asserted interest. The server may include a memory configured to store instructions, a communication module configured to facilitate communications with one or more computing devices and one or more communication network servers, and a processor configured to execute a profile determination module in conjunction with the instructions stored in the memory. The profile determination module may be configured to identify the asserted interest of the person; determine the activities associated with the asserted interest; identify activities actually participated in by the person; and build the profile of the person based on the asserted interest and the activities actually participated in by the person.

The profile determination module may be further configured to determine aspirational and real aspects of the person's online persona, and build a real profile based on the real aspects and an aspirational profile based on the aspirational aspects. The profile determination module may also be configured to enable adjustment of a marketing strategy for the real profile and the aspirational profile, send the real profile and the aspirational profile to a marketing application such that a first marketing strategy is provided for the real profile and a second marketing strategy is provided for the aspirational profile based on a location-specific context, or infer real activities of the person in a physical world from clues associated with the person's online persona. Activities rarely updated online may be presumed to indicate the aspirational aspects and activities updated frequently online may be presumed to indicate the real aspects. Activities indicated as favorite but not otherwise referenced may be presumed to indicate the aspirational aspects and activities referenced in communications may be presumed to indicate the real aspects.

The profile determination module may be configured to integrate a physical world and a virtual world associated with the person by comparing the person's actions and/or behavior in the physical world with what the person asserts about themselves in the virtual world. The profile determination module may further be configured to create a hypothesis on whether a given online networking event involving the person is likely to be a reflection of an aspirational aspect of the person or a real aspect of the person. The online networking event may be associated with one or more of a social network, a professional network, and a blog. The profile determination module may be further configured to test whether the hypothesis is valid or not, where the test includes querying whether the person actually performed an activity they asserted they would perform. The hypothesis may be validated if a strong correlation is determined between the real aspect and the aspirational aspect of the person. The profile determination module may be configured to determine an influencer whose aspirational aspects and real aspects match substantially. The server may be part of one of a data mining entity, a marketing entity, a social network, and/or a professional network.

The present disclosure also describes a computer readable memory device with instructions stored thereon for building a profile for a person based on an asserted interest and actual participation of the person in activities associated with the asserted interest. The instructions may include identifying the asserted interest of the person; determining the activities associated with the asserted interest; identifying activities actually participated in by the person; and building the profile of the person based on the asserted interest and the activities actually participated in by the person.

The instructions may further include determining aspirational and real aspects of the person's online persona; and building a real profile based on the real aspects and an aspirational profile based on the aspirational aspects. The instructions may also include enabling adjustment of a marketing strategy for the real profile and the aspirational profile, providing a first marketing strategy for the real profile and a second marketing strategy for the aspirational profile based on a location-specific context, or inferring real activities of the person in a physical world from clues associated with the person's online persona. Activities rarely updated online may be presumed to indicate the aspirational aspects and activities updated frequently online may be presumed to indicate the real aspects. Activities indicated as favorite but not otherwise referenced may be presumed to indicate the aspirational aspects and activities referenced in communications may be presumed to indicate the real aspects.

The instructions may further include integrating a physical world and a virtual world associated with the person by comparing the person's actions and/or behavior in the physical world with what the person asserts about themselves in the virtual world. The instructions may yet include creating a hypothesis on whether a given online networking event involving the person is likely to be a reflection of an aspirational aspect of the person or a real aspect of the person. The online networking event may be associated with one or more of a social network, a professional network, and a blog. The instructions may include testing whether the hypothesis is valid or not, where the testing includes querying whether the person actually performed an activity they asserted they would perform. The hypothesis may be validated if a strong correlation is determined between the real aspect and the aspirational aspect of the person. The instructions may further include determining an influencer whose aspirational aspects and real aspects match substantially, where the profile is built by one of a data mining entity, a marketing entity, a social network, and/or a professional network.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g.,” a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for building a profile for a person based on an asserted interest and actual participation of the person in activities associated with the asserted interest, the method comprising:
identifying the asserted interest of the person;
determining the activities associated with the asserted interest;
identifying activities actually participated in by the person; and
building the profile of the person based on the asserted interest and the activities actually participated in by the person.

2. The method of claim 1, further comprising:
determining aspirational and real aspects of the person's online persona; and
building a real profile based on the real aspects and an aspirational profile based on the aspirational aspects.

3. The method of claim 2, further comprising:
enabling adjustment of a marketing strategy for the real profile and the aspirational profile.

4. The method of claim 3, further comprising:
providing a first marketing strategy for the real profile and a second marketing strategy for the aspirational profile based on a location-specific context.

5. The method of claim 2, further comprising:
inferring real activities of the person in a physical world from clues associated with the person's online persona.

6. The method of claim 5, wherein activities rarely updated online are presumed to indicate the aspirational aspects and activities updated frequently online are presumed to indicate the real aspects.

7. The method of claim 5, wherein activities indicated as favorite but not otherwise referenced are presumed to indicate the aspirational aspects and activities referenced in communications are presumed to indicate the real aspects.

8. The method of claim 1, further comprising:
integrating a physical world and a virtual world associated with the person by comparing the person's actions and/or behavior in the physical world with what the person asserts about themselves in the virtual world.

9.-15. (canceled)

16. A server for building a profile for a person based on an asserted interest and actual participation of the person in activities associated with the asserted interest, the server comprising:
a memory configured to store instructions;
a communication module configured to facilitate communications with one or more computing devices and one or more communication network servers; and
a processor configured to execute a profile determination module in conjunction with the instructions stored in the memory, wherein the profile determination module is configured to:
identify the asserted interest of the person;
determine the activities associated with the asserted interest;
identify activities actually participated in by the person; and
build the profile of the person based on the asserted interest and the activities actually participated in by the person.

17.-23. (canceled)

24. The server of claim 16, wherein the profile determination module is further configured to:
create a hypothesis on whether a given online networking event involving the person is likely to be a reflection of an aspirational aspect of the person or a real aspect of the person.

25. The server of claim 24, wherein the online networking event is associated with one or more of a social network, a professional network, and a blog.

26. The server of claim 24, wherein the profile determination module is further configured to:
test whether the hypothesis is valid or not.

27. The server of claim 26, wherein the test includes querying whether the person actually performed an activity they asserted they would perform.

28. The server of claim 24, wherein the hypothesis is validated if a strong correlation is determined between the real aspect and the aspirational aspect of the person.

29. The server of claim 24, wherein the profile determination module is further configured to:
determine an influencer whose aspirational aspects and real aspects match substantially.

30. The server of claim 16, wherein the server is part of one of a data mining entity, a marketing entity, a social network, and/or a professional network.

31. A computer readable memory device with instructions stored thereon for building a profile for a person based on an asserted interest and actual participation of the person in activities associated with the asserted interest, the instructions comprising:
identifying the asserted interest of the person;
determining the activities associated with the asserted interest;
identifying activities actually participated in by the person; and
building the profile of the person based on the asserted interest and the activities actually participated in by the person.

32. The computer readable memory device of claim 31, wherein the instructions further comprise:
determining aspirational and real aspects of the person's online persona; and
building a real profile based on the real aspects and an aspirational profile based on the aspirational aspects.

33.-38. (canceled)

39. The computer readable memory device of claim 31, wherein the instructions further comprise:
creating a hypothesis on whether a given online networking event involving the person is likely to be a reflection of an aspirational aspect of the person or a real aspect of the person.

40. (canceled)

41. The computer readable memory device of claim 39, wherein the instructions further comprise:
testing whether the hypothesis is valid or not.

42.-45. (canceled)
